(19) United States
(12) Patent Application Publication
(10) Pub. No.: US 2024/0010023 A1
(43) Pub. Date: Jan. 11, 2024

(54) Paint Roller Cleaning Device

(71) Applicant: Jackie Hendrix, Cushman, AR (US)

(72) Inventor: Jackie Hendrix, Cushman, AR (US)

(21) Appl. No.: 18/055,441

(22) Filed: Nov. 15, 2022

Related U.S. Application Data
(60) Provisional application No. 63/358,968, filed on Jul. 7, 2022.

(51) Int. Cl. B44D 3/00

(52) U.S. Cl. CPC B44D 3/006

(57) ABSTRACT

The present invention relates to a device for thoroughly cleaning paint rollers. The device is comprised of a paint roller cleaning device comprised of a first half, comprised of an opening and at least one connector. The first half attaches to a second half having at least one opening and at least one notch. The connector can connect to a hose to allow water to be supplied to the device. After a paint roller has been placed into the opening of the second half, the roller can be secured to the second half by positioning the stem and handle of the roller into the notch and wherein water can flow through the opening of the first half into the second half and out the opening of the second half to clean the paint roller.

### CROSS-REFERENCE TO RELATED APPLICATION

The present application claims priority to, and the benefit of, U.S. Provisional Application No. 63/358,968, which was filed on Jul. 7, 2022, and is incorporated herein by reference in its entirety.

### FIELD OF THE INVENTION

The present invention relates generally to the field of painting. More specifically, the present invention relates to a paint roller cleaning device comprised of a first half, comprised of an opening and at least one connector, wherein the first half attaches to a second half having at least one opening and at least one notch. The connector can connect to a hose to allow water to be supplied to the device. After a paint roller has been placed into the opening of the second half, the roller can be secured to the second half by positioning the stem and handle of the roller into the notch and wherein water can flow through the opening of the first half into the second half and out the opening of the second half to clean the paint roller. Accordingly, the present disclosure makes specific reference thereto. Nonetheless, it is to be appreciated that aspects of the present invention are also equally applicable to other like applications, devices, and methods of manufacture.

### BACKGROUND

Paint roller pads can be difficult and frustrating to clean. In fact, it is a common occurrence that a roller pad cannot be completely cleaned of paint no matter how long it is rinsed. Further, while cleaning a roller pad water used to clean the pad may spill onto clothing, the floor, and other surroundings. As a result of the pad remaining fully uncleaned, colors may mix if the roller pad is reused.

Therefore, there exists a long-felt need in the art for an improved paint roller cleaning device. There also exists a long-felt need in the art for a paint roller cleaning device that thoroughly removes all paint from a paint roller. In addition, there exists a long-felt need in the art for a paint roller cleaning device that thoroughly removes all paint from a paint roller and reduces the chance of water used to clean the roller splashing onto nearby objects and surfaces. Further, there exists a long-felt need in the art for a paint roller cleaning device that can be easily used with an existing water source.

The subject matter disclosed and claimed herein, in one embodiment thereof, comprises a paint roller cleaning device. The device is comprised of a first half having an opening and at least one connector, wherein the first half attaches to a second half having at least one opening and at least one notch. The connector can connect to a hose to allow water to be supplied to the device. After a paint roller has been placed into the opening of the second half, the roller can be secured to the second half by positioning the stem and handle of the roller into the notch. Water can then flow through the opening of the first half into the second half and out of the opening of the second half to clean the paint roller. The first half and second half are preferably removably attached for easy cleaning, but may also be continuously attached in one embodiment. The device may also be comprised of a handle to allow the device to be easily controlled during use.

In this manner, the paint roller cleaning device of the present invention accomplishes all of the foregoing objectives and provides an improved paint roller cleaning device that removes all paint from a paint roller. During use, the device reduces the chance of water used to clean the roller splashing onto nearby objects and surfaces. In addition, the device can be easily used with an existing water source such as a hose.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a paint roller cleaning device. The device is comprised of a first half, comprised of an opening and at least one connector, wherein the first half attaches to a second half having at least one opening and at least one notch. In the preferred embodiment, the body is generally cylindrical in shape. The first half of the body is comprised of a first end and a second end. The first end is comprised of at least one connector that allows at least one hose to attach to the body to supply water to the device during use. The second end of the first half is comprised of at least one fastener that attaches the second end to at least one reciprocating fastener of the first end of the second half. In the preferred embodiment, the fasteners are reciprocating male and female threads. The second end of the first half also has at least one opening that places the first half in fluid communication with at least one opening of the second half.

The second end of the second half is comprised of at least one notch that receives a stem of a paint roller. By placing the stem into the notch and manipulating the roller within the notch such that the handle is perpendicular to the body, the roller becomes secured within the notch such that it does not dislodge from the second half during use.

The device is also comprised of a method of using the device to clean a paint roller. The connector can be attached to a hose, wherein the first half of the body can be attached to the second half of the body using the fasteners of each half. Then, a paint roller can be inserted into the opening of the second half and the handle/stem of the paint roller can be placed into the notch such that the handle is perpendicular to the body such that the roller is retained in the notch. Once the paint roller has been fully inserted into the second half, the hose can be turned on to allow water to flow into the first half through the connector, into the second half, and out the opening such that paint is removed from the roller pad of the paint roller and can be easily directed to a secondary area for disposal or collection.

Accordingly, the paint roller cleaning device of the present invention is particularly advantageous as it provides an improved paint roller cleaning device that removes all paint from a paint roller. Due to the contained shape of the body, the device reduces the chance of water used to clean the roller splashing onto nearby objects and surfaces. In addition, the device can be easily used with an existing water source such as a hose. In this manner, the paint roller cleaning device overcomes the limitations of existing paint roller cleaning devices known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a side view of one potential embodiment of a paint roller cleaning device of the present invention in accordance with the disclosed architecture;

FIG. 2 illustrates a side view of one potential embodiment of a paint roller cleaning device of the present invention while attached to a hose and while being used to clean a paint roller in accordance with the disclosed architecture;

FIG. 3 illustrates a perspective view of one potential embodiment of a paint roller cleaning device of the present invention while being used to clean a paint roller in accordance with the disclosed architecture;

FIG. 4 illustrates a flow chart of a method of using one potential embodiment of a paint roller cleaning device of the present invention in accordance with the disclosed architecture; and

FIG. 5 illustrates a cross-sectional side view of one potential embodiment of a paint roller cleaning device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved paint roller cleaning device. There also exists a long-felt need in the art for a paint roller cleaning device that thoroughly removes all paint from a paint roller. In addition, there exists a long-felt need in the art for a paint roller cleaning device that thoroughly removes all paint from a paint roller and reduces the chance of water used to clean the roller splashing onto nearby objects and surfaces. Further, there exists a long-felt need in the art for a paint roller cleaning device that can be easily used with an existing water source.

The present invention, in one exemplary embodiment, is comprised of a paint roller cleaning device comprised of a first half having an opening and at least one connector wherein the first half attaches to a second half having at least one opening and at least one notch. The body is preferably generally cylindrical in shape. The first half of the body is comprised of a first end and a second end. The first end is comprised of at least one connector that allows at least one hose to attach to the body to supply water to the device during use. The second end of the first half is comprised of at least one fastener that attaches the second end to at least one reciprocating fastener of the first end of the second half. In the preferred embodiment, the fasteners are reciprocating male and female threads. The second end of the first half also has at least one opening that places the first half in fluid communication with at least one opening of the second half.

The second end of the second half is comprised of at least one notch that receives a stem of a paint roller. By placing the stem into the notch and manipulating the roller within the notch such that the handle is perpendicular to the body, the roller becomes secured within the notch such that it does not dislodge from the second half during use.

The device is also comprised of a method of using the device to clean a paint roller. The connector can be attached to a hose, wherein the first half of the body can be attached to the second half of the body using the fasteners of each half. Then, a paint roller can be inserted into the opening of the second half and the handle/stem of the paint roller can be placed into the notch such that the handle is perpendicular with the body, such that the roller is retained in the notch. Once the paint roller has been fully inserted into the second half, the hose can be turned on to allow water to flow into the first half through the connector, into the second half, and out the opening such that paint is removed from the roller pad of the paint roller and can be easily directed to a secondary area for disposal or collection.

Accordingly, the paint roller cleaning device of the present invention is particularly advantageous as it provides an improved paint roller cleaning device that removes all paint from a paint roller. Due to the contained shape of the body, the device reduces the chance of water used to clean the roller splashing onto nearby objects and surfaces. In addition, the device can be easily used with an existing water source such as a hose. In this manner, the paint roller cleaning device overcomes the limitations of existing paint roller cleaning devices known in the art.

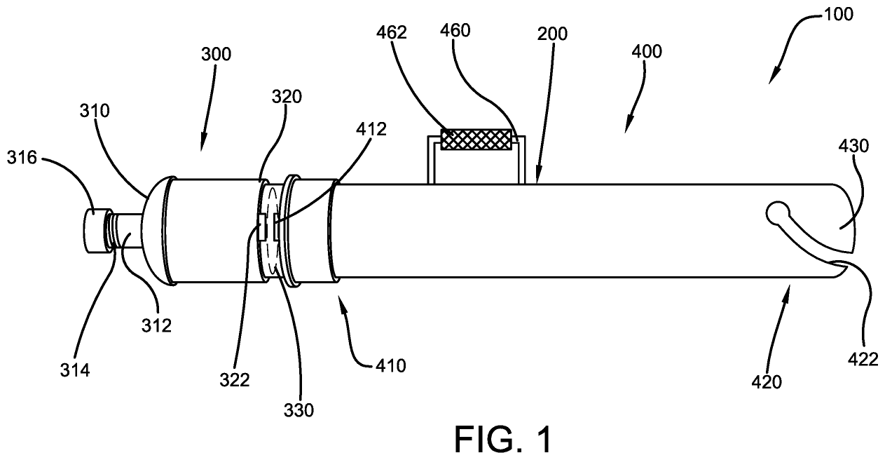

Referring initially to the drawings, FIG. 1 illustrates a side view of one potential embodiment of a paint roller cleaning device 100 of the present invention in accordance with the disclosed architecture. The device 100 is comprised of a first half 300, comprised of an opening 330 and at least one connector 312, wherein the first half 300 attaches to a second half 400 having at least one opening 430 and at least one notch 422. The device 100 and all components are preferably made from a rigid plastic material such as, but not limited to, acrylic, polycarbonate, polyethylene, thermoplastic, acrylonitrile butadiene styrene, low-density polyethylene, medium-density polyethylene, high-density polyethylene, polyethylene terephthalate, polyvinyl chloride, polystyrene, polylactic acid, acetal, nylon, fiberglass, recycled plastic, biodegradable plastic, etc., or a durable, corrosion-resistant metal such as, but not limited to, stainless steel, aluminum, etc. In the preferred embodiment, the body 200 is generally cylindrical in shape. Although, the body 200 may be different shapes in various embodiments such as, but not limited to, square, triangular, etc.

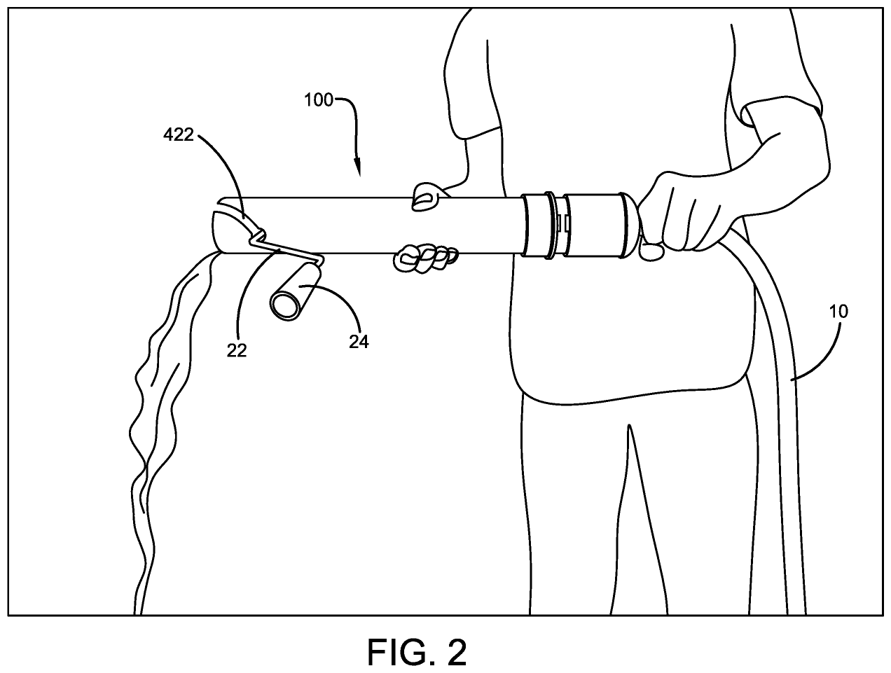

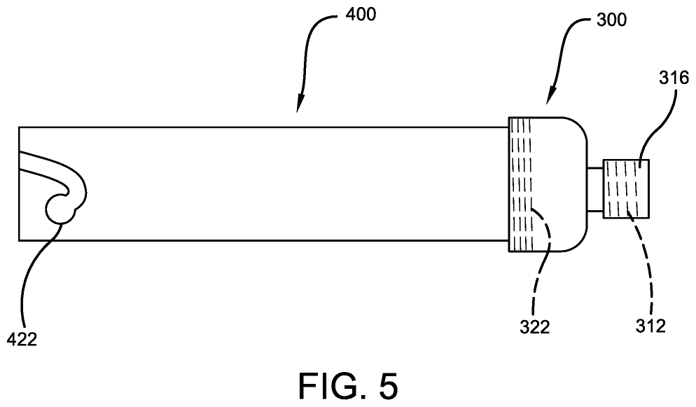

The first half 300 of the body 200 is comprised of a first end 310 and a second end 320. The first end 310 is comprised of at least one connector 312. In the preferred embodiment, the connector 312 may be a male or female connector 312 that allows at least one hose 10 to attach to the body 200 to supply water to the device 100 during use. In the preferred embodiment, the connector 312 may have a plurality of male or female threads 314 to facilitate connection to a hose 10, as seen in FIG. 2 and FIG. 5. In one embodiment, the connector 312 is a male or female quick-connect connector or another similar connector of the like that can connect to any hose 10 known in the art. When not in use, the connector can be covered by at least one cap 316. In one embodiment, the cap 316 is a threaded cap that can be secured to the threads 314 of the connector 312. However, in one embodiment, the cap 316 is a flexible silicone cap that can be stretched over the connector 312.

The second end 320 of the first half 300 is comprised of at least one fastener 322 that attaches the second end 320 to at least one reciprocating fastener 412 of the first end 410 of the second half 400. In the preferred embodiment, the fasteners 322, 412 are reciprocating male and female threads. However, the fasteners 322, 412 may also be quick-connectors or other similar connectors of the like.

The second end 320 of the first half 300 also has at least one opening 330 that places the first half 300 in fluid communication with at least one opening 430 of the second half 400.

The second end 420 of the second half 400 is comprised of at least one notch 422. The notch 422 allows the stem 22 of a paint roller 20 to be secured to the body 200 while the device 100 is used to clean the paint roller 20. By placing the roller 20 into the notch 422 and manipulating the roller 20 within the notch 422 such that the handle 24 is perpendicular to the body 200, the roller 20 becomes secured within the notch 422 such that it does not dislodge from the second half 400 during use.

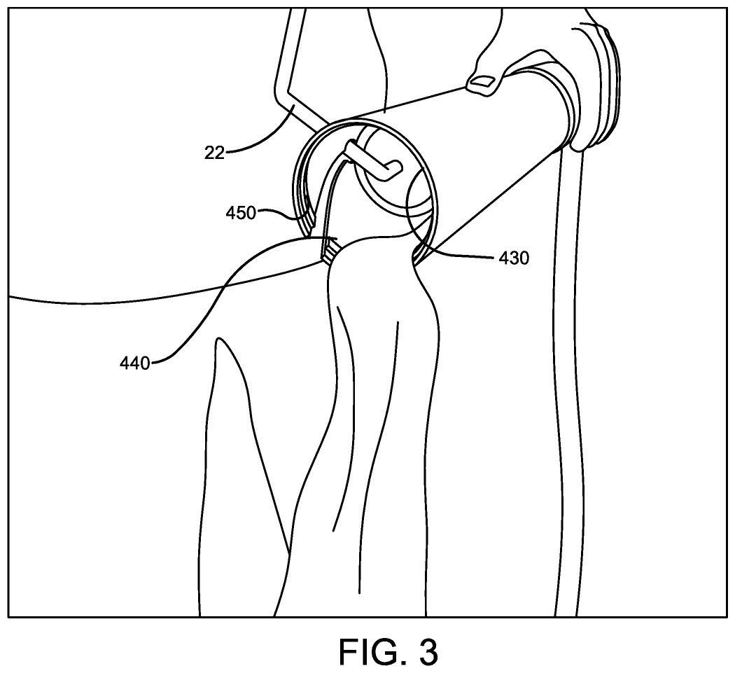

FIG. 3 illustrates a perspective view of one potential embodiment of a paint roller cleaning device 100 of the present invention while being used to clean a paint roller 20 in accordance with the disclosed architecture. In one embodiment, the interior surface 440 of the second half 400 is comprised of at least one lining 450. The lining 450 is preferably (but not limited to) ⅜″ thick, soft rubber lining. The lining 450 collapses when a roller 20 is placed into the device 100 such that water pressure is confined to pass through the roller pad 20.

In one embodiment, the body 200 is comprised of at least one handle 460 that allows a user to better control the body 200 during use. The handle 460 may be comprised of at least one grip area 462. The grip area 462 may be textured with a recessed or raised texture or may be non-textured. The grip area is preferably made from a non-slip material that improves grip such as, but not limited to, silicone, latex, neoprene, EPDM, PVC foam, polyethylene, sponge rubber, silicone foam, urethane, cork, ridged and/or recessed rubber, felt, acrylic, polyester & SBR, etc.

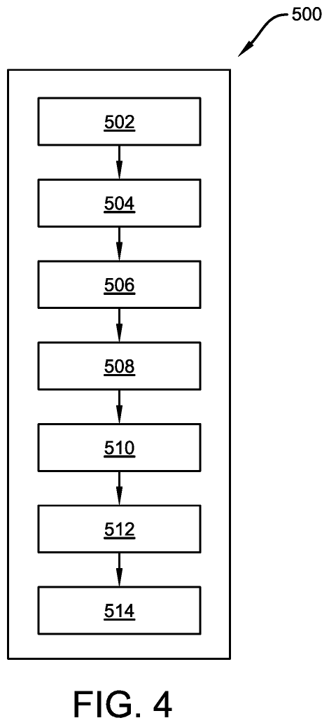

FIG. 4 illustrates a flow chart of a method of using 400 one potential embodiment of a paint roller cleaning device 100 of the present invention in accordance with the disclosed architecture. The device 100 is also comprised of a method of use 500. First, the cap 316 is removed from the connector 312 of the first half 300 [Step 502]. Then, the connector 312 can be attached to a hose 10 [Step 504]. Next, the first half 300 of the body 200 can be attached to the second half 400 of the body 200 using the fasteners 322, 412 of each half 300, 400 [Step 506]. Then, a paint roller 20 can be inserted into the opening 430 of the second half 400 [Step 508]. Next, the stem 22 of the paint roller 20 can be placed into the notch 422 such that the handle 24 is perpendicular with the body 200 such that the roller 20 is retained in the notch [Step 510]. Once the paint roller 20 has been fully inserted into the second half 400, the hose 10 can be turned on to allow water to flow into the first half 300 through the connector 312, into the second half 400, and out the opening 430 such that paint is removed from the roller pad 26 of the paint roller 20 and can be easily directed to a secondary area for disposal or collection [Step 512]. The second half 400 can then be removed from the first half 300 for cleaning as needed after the roller 20 has been removed [Step 514].

It should be appreciated that in one embodiment, the body 200 is continuous and has a first half 300 that is inseparable from the second half 400.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “paint roller cleaning device” and “device” are interchangeable and refer to the paint roller cleaning device 100 of the present invention.

Notwithstanding the foregoing, the paint roller cleaning device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the paint roller cleaning device 100 as shown in the FIGS. are for illustrative purposes only, and that many other sizes and shapes of the paint roller cleaning device 100 are well within the scope of the present disclosure. Although the dimensions of the paint roller cleaning device 100 are important design parameters for user convenience, the paint roller cleaning device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A paint roller cleaning device comprising:
a body;
a connector;
an opening; and
a notch.

2. The paint roller cleaning device of claim 1, wherein the connector is comprised of a male connector.

3. The paint roller cleaning device of claim 2, wherein the connector is comprised of a plurality of threads.

4. The paint roller cleaning device of claim 1, wherein the connector is comprised of a quick-connect connector.

5. The paint roller cleaning device of claim 1, wherein an interior surface of the body is comprised of a lining.

6. A paint roller cleaning device comprising:
a first half comprised of a connector, a first opening and a first fastener;
a second half comprised of a second opening, a second fastener and a notch; and
a cap.

7. The paint roller cleaning device of claim 6, wherein the cap is comprised of a threaded cap.

8. The paint roller cleaning device of claim 6, wherein the cap is comprised of a flexible silicone cap.

9. The paint roller cleaning device of claim 6, wherein the first fastener is comprised of a plurality of threads.

10. The paint roller cleaning device of claim 9, wherein the second fastener is comprised of a plurality of reciprocating threads.

11. The paint roller cleaning device of claim 6, wherein the first opening is in fluid communication with the second opening.

12. The paint roller cleaning device of claim 6, wherein an interior surface of the second half is comprised of a lining.

13. The paint roller cleaning device of claim 12, wherein the lining is comprised of a foam material.

14. The paint roller cleaning device of claim 6, wherein the first fastener is comprised of a quick-connect fastener.

15. The paint roller cleaning device of claim 6, wherein the second fastener is comprised of a quick-connect fastener.

16. The paint roller cleaning device of claim 6, wherein the first half is comprised of a cylindrical shape.

17. The paint roller cleaning device of claim 6, wherein the second half is comprised of a cylindrical shape.

18. The paint roller cleaning device of claim 6 further comprised of a handle.

19. A method of using a paint roller cleaning device, the method comprising the steps of:
attaching a connector of the paint roller cleaning device to a hose;
inserting a paint roller into an opening of the paint roller cleaning device;
placing a stem of the paint roller into a notch of the paint roller cleaning device; and
turning on the hose to allow water to flow through the paint roller cleaning device to clean the paint roller.

20. The method of claim 19, wherein the stem of the paint roller is placed into the notch such that a handle of the paint roller is perpendicular with a body of the paint roller cleaning device such that the paint roller is retained in the notch.
